(19) United States
(12) Patent Application Publication
(10) Pub. No.: US 2001/0031335 A1
(43) Pub. Date: Oct. 18, 2001

(54) Indoor and outdoor screen printed art and method of manufacturing

(76) Inventor: Robert H. Hackett, Oakmont, PA (US)

Correspondence Address: Frederick B. Ziesenheim, 700 Koppers Building, 436 Seventh Avenue, Pittsburgh, PA, 15219-1818, US

(21) Appl. No.: 09/740,334

(22) Filed: Dec. 18, 2000

Related U.S. Application Data
(60) Provisional application No. 60/171,050, filed on Dec. 16, 1999.

(51) Int. Cl. B32B 3/00

(52) U.S. Cl. 428/157; 428/172

(57) ABSTRACT

The present invention is a decorative piece of art including a metallic substrate. The metallic substrate has a substantially planar inner portion and an embossed peripheral portion. The present invention further includes a combined image printed on one entire surface of the metallic substrate, the combined image including a reproduction of a first image printed on the planar portion of the substrate, and a reproduction of a frame printed on the embossed peripheral portion of the substrate. The present invention also includes a method of producing a durable, decorative piece of art, including the steps of: providing a combined image having a central image surrounded by a frame image; transferring the combined image to a metallic substrate, wherein the combined image covers one entire surface of the substrate; and embossing the metallic substrate in those areas of the substrate having the frame image.

### BACKGROUND OF THE INVENTION

1. Field of the Invention

The present invention relates to ornamental, decorative artwork and, in particular, to aesthetically pleasing, durable indoor and outdoor screen printed art and the method of manufacturing thereof.

2. Description of the Prior Art

The use of a screen printing process to accurately reproduce an original colored picture or image onto a surface is well-known. Basically, a frame is covered with a fabric, usually formed of a frame with the screen on the bottom. Certain portions of the screen are covered, rendering those sections of the screen impervious. The appropriate color is applied to the screen. Using pressure, the color is forced through the pervious portions of the screen and applied to the surface. This process is repeated with varying colors until the surface contains the image or picture.

It is also well-known in the art to use varying surfaces to receive the image. The screen printing process may be utilized to reproduce pictures and images on many substrates, e.g., wooden, metallic, leather, glass, etc. Once completed, the object contains the desired image and may be utilized for its purpose as a picture, sign or other function.

While neither the screen printing process, nor the use of various surfaces upon which to apply an image, are new, there is an aesthetic need for a method and apparatus for reproducing original images, e.g., oil paintings, water colors, pastels, etc., on a metallic substrate, which can be used with equal effect both indoors and outdoors. Merely placing the image on the substrate produces a piece of artwork that appears like a sign. While this may be useful for outdoor applications, i.e., advertising signs, it would be aesthetically unappealing if used indoors.

### SUMMARY OF THE INVENTION

It is, therefore, an object of the present invention to create a screen printed reproduction of an original piece of artwork on a metallic surface, which can be used in both indoor and outdoor applications. It is a further object of this invention to create a reproduced original oil painting on a metallic surface with a realistic appearing frame around the screen printed painting.

Accordingly, I have invented a decorative piece of art including a metallic substrate. The metallic substrate has a substantially planar inner portion and an embossed peripheral portion. The present invention also includes a combined image printed on one entire surface of the metallic substrate. This combined image includes a reproduction of a first image printed on the planar portion of the substrate and a reproduction of a frame image printed on the embossed peripheral portion of the substrate. The present invention also provides a method of producing a durable, decorative piece of art, including the steps of: providing a combined image having a central image surrounded by a frame image; transferring the combined image to a metallic substrate, wherein the combined image covers one entire surface of substrate; and embossing the metallic substrate in those areas of the substrate having the frame image thereon.

The present invention includes an apparatus and method of manufacturing a screen printed reproduction of an original piece of artwork on a metallic substrate, for use in both indoor and outdoor applications. After the original piece of art, e.g., an oil painting, is created, the artist also provides a frame or border around the artwork; the frame colors complimenting the artwork composition. Once the frame and the artwork combination is finished, the basic process includes transferring, via a conventional screen printing process, the artwork/frame image combination onto a metallic surface that is sized exactly to the image combination. After the artwork/frame image combination is screened on the surface and dried, a protective top coat and a polyurethane film are applied over the image for protective purposes in both subsequent manufacturing and shipping operations.

The image on the surface, along with the top coat and the film, are trimmed for bleed-off. Holes are punched or scored on the frame section. Next, the metallic surface with the image applied thereon is embossed around the frame section, creating a three-dimensional frame around the painting. Once completed, the film remains on the image to protect the painting and frame during shipping.

The buyer removes the film upon receipt of the invention and has a framed piece of artwork, wherein the frame is three-dimensional and appears as a realistic wooden frame. As the invention is metallic, the invention may be used equally in both indoor and outdoor applications. Even in extreme outdoor weather conditions, the invention retains its original color and dimensions for years. However, in indoor conditions, the invention still appears as an original work of art with a wooden frame around it. Further, the inventions can be attached together to create a themed mobile.

### BRIEF DESCRIPTION OF THE DRAWINGS

FIG. 1 shows a front view of the present invention;

FIG. 2 shows a cross-sectional view of the present invention;

FIG. 3 shows a front view of the present invention with another painting and frame combination;

FIG. 4 shows the enlarged sectional view of a portion of the present invention; and

FIG. 5 shows a side view of a mobile made according to the present invention.

### DETAILED DESCRIPTION OF THE PREFERRED EMBODIMENTS

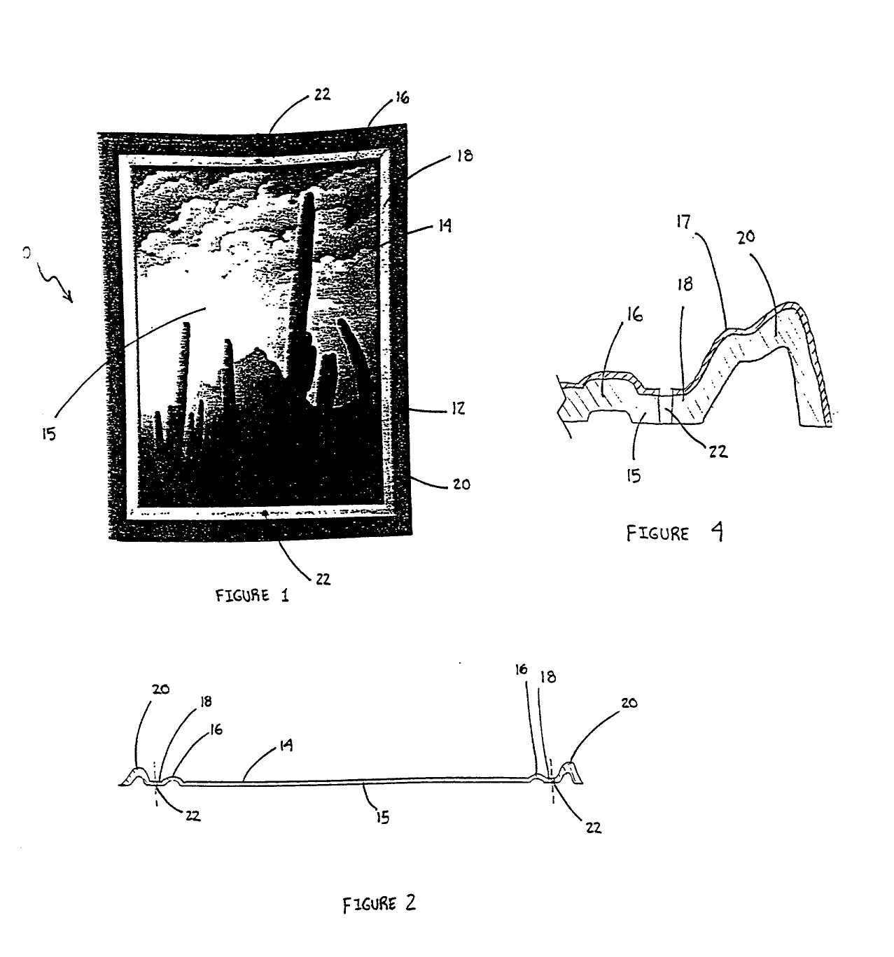

The present invention is a screen printed representation of an image, e.g., an original oil painting, and embossed frame combination formed on a metallic substrate, for use in both indoor and outdoor applications. Other image types, such as water colors, pastels or charcoal, may be used. As illustrated in FIG. 1, the present invention 10 includes a screen printed image 14 surrounded by a screen printed frame 12. Both the screen printed image 14 and the screen printed frame 12 are applied to a metallic substrate 15, which may be aluminum, galvanized steel or any other suitable, weather-resistant embossible material. Once created, the present invention 10 can be used effectively and aesthetically both inside and outside (e.g., on a deck, patio walls, building exterior, fence, in a flower garden, etc.).

In one embodiment, the screen printed image 14 is that of an original oil painting. This original painting can be formed on any normal substrate which is capable of normal reproduction. Further, the painting may be any shape or size, but is typically rectangular in form. Once the artist has completed the painting, the artist then provides a complimentary frame bordering the painting surface. Typically, the frame would be a wooden frame having colors and contours selected to properly highlight and compliment the painting. Alternatively, the artist can paint or otherwise create the image of an appropriate frame surrounding the original painting.

The painting and frame image combination is photographed and then applied to the metallic substrate 15, using any conventional screen printing process. For example, a 65- to 85-line half-tone screen printing process is envisioned. The metallic substrate 15, such as aluminum, is sized to be the same as the image combination, such that the entire outer surface of the metallic substrate 15 is covered with the combined image. Next, the image combination is coated with an ultraviolet-ray protective top coat.

Once the screen printed image 14 and the screen printed frame 12 are applied to the metal substrate 15 and the top coat applied, the entire combined image (i.e., the entire outer facing surface of the metallic substrate 15) is covered with a protective film 17, such as polyurethane film. This protective film 17 has the dual purpose of protecting the present invention during the next processing step, as well as protecting the screen printed image 14 and the screen printed frame 12 during the shipping process. After the protective film 17 is applied, the metallic substrate 15 is trimmed for bleed-off. Next, mounting holes 22 are punched or scored on certain predetermined locations on the metallic substrate 15 for hanging purposes. The number of mounting holes 22 can range from one to any number required to properly affix the invention 10 to a fixture. In general, one mounting hole 22 will be placed on the top of the invention 10 and one hole 22 will be placed on the bottom of the invention 10 with the top and bottom of the invention 10 determined by the orientation of the image 14.

Returning to FIG. 1, the screen printed frame 12 may include three basic and distinct frame areas. Immediately surrounding the screen printed image 14 is a first, normally dark-colored border 16. This first border 16 serves to set the viewer=s boundaries around the screen printed image 14. Immediately surrounding the first border 16 is a second border 18 which is utilized to further clarify and center the viewer=s boundaries around the screen printed image 14. This second, normally lighter colored border 18 is preferably flush with the plane upon which the screen printed image 14 is oriented. Finally, immediately surrounding the second light-colored border 18 is the third decorative, generally wooden appearing border 20.

Once the screen printed image 14 and the screen printed frame 12, including the first border 16, the second border 18 and the third decorative wooden-appearing border 20, are applied to the metallic substrate 15 and covered with a top coat and a protective film 17, the mounting holes 22 are punched or scored, and the present invention 10 is moved to the embossing step. In this step, the metallic substrate 15 is machined to form or emboss the screen printed frame 12, creating a three-dimensional look. The embossing may be performed by a hydraulic press having relevant dies as known in metal working. As seen in FIG. 2, the first border 16, the second border 18 and the third decorative wooden-appearing border 20 are all shaped differently according to the design of the frame 12. Once embossed, the screen printed frame 12 appears to have a true wooden frame around an original work of art. The now embossed screen printed frame 12 casts the same shadows and maintains the same visual effects as a true wooden frame would create. The screen printed image 14 and the colors of the screen printed frame 12 may be altered without changing the embossing process. In this manner, a single set of dies for the embossing machine may be used for a wide variety of screen printed frames 12. The screen printed frame 12 may vary only in color to compliment the new screened image 14 but obviating the need to modify the pressing and forming process. However, of course, different shapes and forms of the screen printed frame 12 are envisioned here.

Once completed, the protective film, which protected the screen printed image 14 and the screen printed frame 12 during the embossing step, may remain on the present invention 10, protecting the present invention 10 during the shipping process. When the consumer purchases the present invention 10, the consumer may then remove the protective film and enjoy a realistic representation of an original work of art with a realistic wooden frame around it.

In another embodiment, as illustrated in FIG. 5, the present invention includes the use of two separate inventions 10 attached back to back via the mounting holes 22 to form a mobile. Specifically, the inventions 10 are placed back to back, matching the mounting holes 22 and inserting an attachment fixture 24, e.g., a pop rivet or screw/nut combination, through the mounting holes 22. Once attached, a support line 26 is attached to one of the attachment fixtures 24 and further secured to an overhang via an eyelet 28.

In this manner, the present invention creates a hanging mobile for use outside, particularly in the garden area. This lightweight, two-sided mobile, with two different screen printed images 14 and/or screen printed frames 12 back to back, will interact with one another to create an interesting theme.

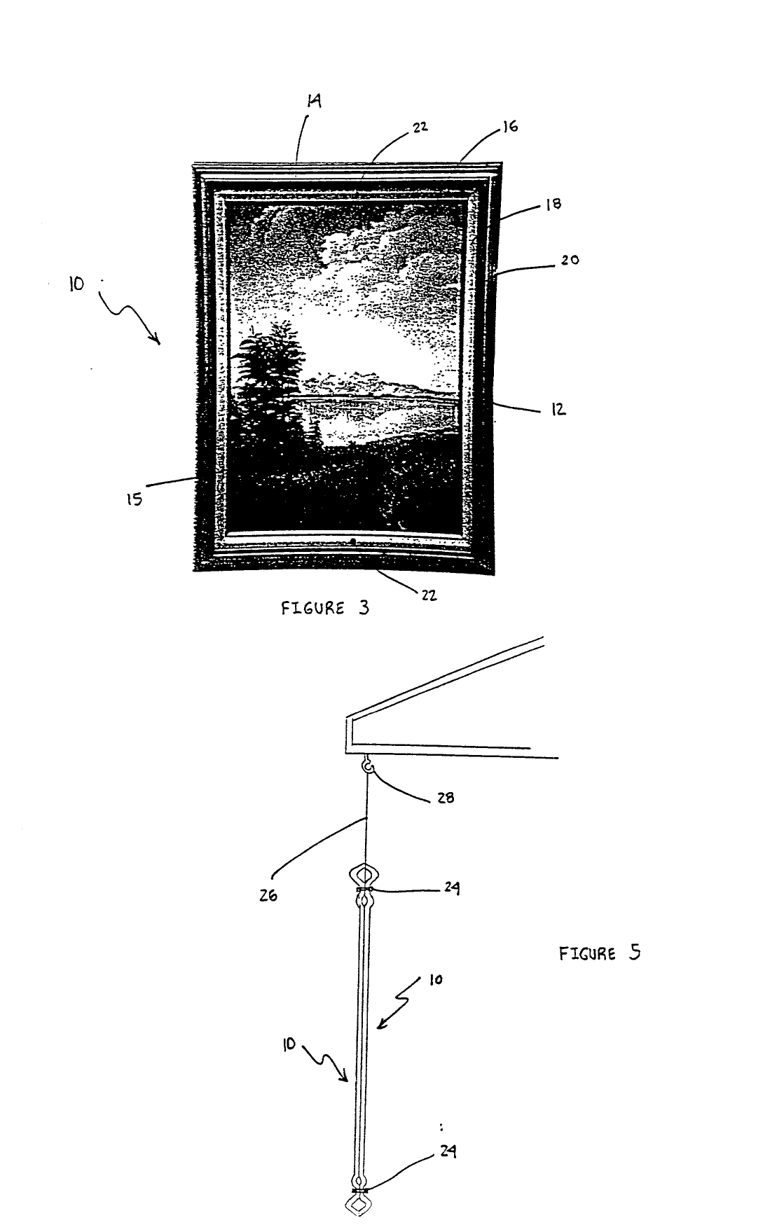

When used indoors, the present invention 10 is not easily distinguished from a typical wooden-framed painting by the typical viewer. Further, when placed outside, the present invention 10 is an aesthetically pleasing addition to the outside living area, such as decks, patios, gardens and pool areas. Even during repeated and extreme weather conditions, the present invention 10 maintains its original appearance for many years. In addition, the consumer may purchase different screen printed images 14 with different and complimentary screen printed frames 12, as seen in FIG. 3.

The protective top coat on the present invention 10 is provided to protect the screen printed image 14 and screen printed frame 12 from harmful ultraviolet-rays. The combination of this protective top coat with the metallic substrate 15 of the present invention 10 allows the color of the present invention 10 to remain fast for many years. It is also envisioned that the attachment fixture 24 color is identical to the color of the area, e.g., the second border 18, through which the mounting holes 22 are created.

Overall, the present invention 10 recreates an aesthetic and realistic looking wooden-framed original image on a durable, weather-resistant metallic surface. It is difficult to distinguish the present invention 10 from the actual framed artork. Further, the present invention 10 may be used in both indoor and outdoor applications, yielding equally aesthetic enhancements to both areas. However, as the present invention 10 is formed on a metallic substrate, the screen printed image 14 and screen printed frame 12 remain intact through years of seasonal variations and extreme weather conditions.

It will be evident to those of ordinary skill in the art that various changes and modifications may be made to the present invention without departing from the spirit and scope thereof.

I claim:

1. A decorative piece of art, comprising:
a metallic substrate having a substantially planar inner portion and an embossed peripheral portion; and
a combined image printed on one entire surface of the metallic substrate, the combined image including a reproduction of a first image printed on the planar portion of the substrate, and a reproduction of a frame printed on the embossed peripheral portion of the substrate.

2. The decorative piece of art of claim 1, wherein the reproduction of the first image is a reproduction of an oil painting and the reproduction of the frame resembles a wooden frame.

3. The decorative piece of art of claim 2, wherein the frame includes a first border adjacent the reproduction of the first image colored to contrast with the first image, a second border adjacent the first border and colored to contrast with the first border and a third border surrounding the second border.

4. A method of producing a durable, decorative piece of art, comprising the steps of:
providing a combined image having a central image surrounded by a frame image;
transferring the combined image to a metallic substrate, wherein the combined image covers one entire surface of the substrate; and
embossing the metallic substrate in those areas of the substrate having the frame image.

5. The method of claim 4, further comprising the step of laminating the printed surface of the substrate with a protective top coat prior to embossing.

6. The method of claim 5, further comprising the step of punching a plurality of mounting holes through the frame image.

7. The method of claim 6, further comprising the step of applying a protective film over the printed surface of the substrate prior to embossing.

8. The method of claim 7, wherein the central image is an oil-based painting.

9. The method of claim 7, wherein the central image is a water color-based painting.

10. The method of claim 7, wherein the central image is a charcoal-based image.

11. The method of claim 7, wherein the central image is a pastel-based image.

12. The method of claim 6, further comprising the step of securing the frame to an object, wherein the attachment fixture is inserted through the mounting hole and affixed to the object.

13. The method of claim 12, further comprising the steps of:
placing two decorative art pieces back to back;
securing the frame of one decorative art piece to the second decorative art piece by inserting the attachment fixture through a mounting hole of the frame image of one decorative art piece, continuing through a corresponding mounting hole of the frame image of the second decorative art piece;
attaching one end of a support line to the attachment fixture;
attaching a second end of a support line to an eyelet; and
securing the eyelet to an object.

14. The method of claim 13, wherein the attachment fixture is colored identically to a portion of the frame image through which the mounting hole is punched.

15. The method of claim 4, further comprising the step of scoring a plurality of mounting holes through the frame image.

16. The method of claim 4, wherein the frame image is a representation of a wooden frame.

17. The method of claim 8, wherein the frame image is painted around the oil-based painting.

18. The method of claim 4, wherein the frame image includes a first border adjacent the reproduction of the central image, a second border adjacent the first border and a third border surrounding the second border.

19. A mobile comprising a pair of decorative pieces of art according to claim 1.

20. The mobile according to claim 19, wherein the pieces of art are attached back-to-back.
